(19) United States
(12) Patent Application Publication
(10) Pub. No.: US 2025/0229412 A1
(43) Pub. Date: Jul. 17, 2025

(54) MOBILE LOGISTICS ROBOT

(71) Applicant: Dexterity, Inc., Redwood City, CA (US)

(72) Inventors: Joseph Li, San Jose, CA (US); Robert Moreno, East Palo Alto, CA (US); James Levin, Sparta, NJ (US); Yue Shi, San Mateo, CA (US); Gil Matzliach, Sunnyvale, CA (US); Cyril Nader, Redwood City, CA (US); Prabhat Kumar Sinha, Santa Clara, CA (US); Samir Menon, Atherton, CA (US)

(21) Appl. No.: 19/018,838

(22) Filed: Jan. 13, 2025

Related U.S. Application Data
(60) Provisional application No. 63/621,494, filed on Jan. 16, 2024.

(51) Int. Cl. B25J 5/00; B25J 9/00; B25J 9/16

(52) U.S. Cl. CPC B25J 5/007; B25J 9/0093; B25J 9/1682; B25J 9/1697

(57) ABSTRACT

A mobile logistics robot is disclosed. The robot includes a mobile chassis having a plurality of independently controllable drive elements; one or more robotic arms mounted on the mobile chassis; and a processor configured to control the one or more robotic arms and the plurality of independently controllable drive elements as needed to pick items from a set of one or more source locations and place each item in a corresponding destination location included in a set of one or more destination locations, including by using the independently controllable drive elements to move the mobile chassis within a space bounded at least in part by the one or more source locations and the one or more destination locations.

### CROSS REFERENCE TO OTHER APPLICATIONS

This application claims priority to U.S. Provisional Patent Application No. 63/621,494 entitled MOBILE LOGISTICS ROBOT filed Jan. 16, 2024 which is incorporated herein by reference for all purposes.

### BACKGROUND OF THE INVENTION

Typically, item packing and unpacking operations, such as palletization and depalletization, are manually performed by human operators or large, static robots.

For single SKU (i.e., stock keeping unit) palletization, involving building a pallet by stacking a plurality of the same item, which typically is performed via “end of line” palletizing (i.e., items brought to human worker or robot, e.g., via a conveyor or chute), large, static robots typically are used. These systems functionally work but require a large footprint and high capital investment.

For mixed SKU palletization, palletization may be performed either via end of line palletizing (goods brought to person/robot) or via “order shopping”, in which one or more humans and/or robots go to retrieve items, e.g., each from a corresponding location. Mixed SKU end of line palletizing typically is done by operators manually. This process is manual, inefficient, and injury prone. In some instances, end of line mixed case palletization has been automated. Typically, this is done through large static robots with an extremely large footprint and high capital cost. Furthermore, these systems require the case infeed to be entirely pre-sequenced in the exact order. This option is exclusively available to the very few customers who can invest in a greenfield building with an automated storage retrieval system.

Some other static robots can perform random sequence mixed case palletization. However, even smaller static robots often have a very large footprint given the need for a large guarded safety zone. Such setups typically do not fit inside brownfield layouts and have fundamental limitations on pallet reach and reach to the buffer.

For mixed SKU order shopping (i.e., person to goods), typically a human worker would need to drive a forklift, order picker, or walkie around with a pallet and build the mixed pallet as they drive through the warehouse. This process is manual, inefficient, and injury prone.

In the case of mixed or single SKU depalletization, e.g., depalletization to a sorter (goods to person/robot), the process can be automated by a static robot, but it often takes up a very large footprint within the warehouse. Furthermore, since depalletization is a low utilization use case, many customers cannot justify installing bolted down hardware for a low utilization application.

For pick module depalletization (person to goods), typically a person would need to walk through a pick module and manually depalletize the items needed. This process is inefficient and injury prone.

### BRIEF DESCRIPTION OF THE DRAWINGS

Various embodiments of the invention are disclosed in the following detailed description and the accompanying drawings.

FIG. 1 is a diagram illustrating an embodiment of a multi-purpose robotic system.

FIG. 2 is a block diagram illustrating an embodiment of a multi-purpose robotic system.

FIG. 3 is a flow diagram illustrating an embodiment of a process to configure a multi-purpose robotic system as/if needed to perform work.

FIG. 4 is a flow diagram illustrating an embodiment of a process to configure and/or reposition a multi-purpose robotic system as/if needed to perform work.

FIG. 5 is a flow diagram illustrating an embodiment of a process for a multi-purpose robotic system to work safely with other human or robotic workers.

FIG. 6 is a diagram illustrating an embodiment of a multi-purpose robotic system configured to pick and place items safely in the presence of a human worker.

FIGS. 7A and 7B illustrate an embodiment of a multi-purpose robotic system configured to pick, label, and place items.

FIG. 8 illustrates an embodiment of a multi-purpose robotic system configured to pick and place items, including by moving freely in x-y space.

FIG. 9 illustrates an embodiment of a multi-purpose robotic system configured to pick and place items to perform sortation and/or kitting operations.

FIG. 10 is a block diagram illustrating an embodiment of a multi-purpose robotic system having a novel form factor.

FIG. 11 illustrates a multi-purpose robotic system comprising a plurality of multi-purpose mobile robots operating safely in an environment in which a human worker is present.

FIG. 12 illustrates a multi-purpose robotic system configured to pick/place items, including by moving laterally alongside a conveyance structure and a row of pallets or other receptacles.

FIGS. 13A and 13B illustrate a multi-purpose robotic system capable of pivoting about an arbitrary vertical axis.

FIGS. 14A and 14B illustrate a multi-purpose robotic system configured to operate beneath a conveyance structure, picking/placing items between the conveyance structure and adjacent pallets or other receptacles.

FIGS. 15A and 15B illustrate a multi-purpose robotic system comprising a plurality of multi-purpose mobile robots cooperating to load/unload a truck or other container, including by picking/placing items to/from a conveyance structure configured to convey items between the truck or other container and sets of pallets or other receptacles located near the conveyance structure.

FIGS. 16A and 16B illustrate a multi-purpose robotic system comprising a plurality of multi-purpose mobile robots cooperating to load/unload a truck or other container, including by picking/placing items to/from a conveyance structure configured to convey items between the truck or other container and sets of pallets or other receptacles arranged in rows and/or columns.

FIGS. 17A and 17B illustrate a multi-purpose robotic system comprising a plurality of multi-purpose mobile robots cooperating to load/unload a truck or other container, including by using buffer zones to hold items for later placement.

FIG. 18 is a flow diagram illustrating an embodiment of a process implemented by a multi-purpose robotic system comprising a plurality of multi-purpose mobile robots cooperating to load/unload a truck or other container, including by using buffer zones to hold items for later placement.

FIG. 19 illustrates a multi-purpose robotic system configured to load/unload items to/from a plurality of trucks or other containers, including by navigating autonomously into, out of, and/or between trucks or other containers.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A mobile logistics robot/robotic system is disclosed. In various embodiments, mobile robots (one or many/fleet) as disclosed herein are used to perform palletizing, depalletizing, and other derivative workflows involving picking and placing objects into and out of containers including but not limited to pallets, pallet racking, totes, shelves, trays, rolling carts, gaylords, unit load devices (ULDs), etc.

In various embodiments, a robotic system as disclosed herein overcomes or mitigates one or more of the following technical challenges:

Challenge 1: Large Capital Investment needed. For current end of line mixed case palletization automation to work, boxes typically must be fed in a known pre-sequence. To do so, a significant amount of capex needs to be invested in a random-access automated storage retrieval system (AS/RS). These capital investments are usually north of $50MM and require a greenfield building. Because of such requirements, most of the market have not adopted this approach.

Challenge 2: Significant Floorspace Investment needed. For current end of line mixed case palletization automation, static robots require a significant floor space (driven by safety and size of robot itself). Because static robots are large and take up significant floor space, there are only a minority of buildings that they would fit in.

Challenge 3: Limitations on reach of Static Robot. Many uses cases either require building pallets or other receptacles at a large number of locations (e.g. 15-20 pallets a lane) and/or building a full 2.4 m tall pallet with a highly complex SKU mix. The reach of a static robot presents two problems—(1) it cannot scale beyond reaching a set number of pallets around the robot (e.g. 8 pallets) and when doing so it breaks the floorspace constraint and (2) when static robots scale the number of pallets, it becomes a tradeoff with robot reach. Therefore, when applying both constraints at once, static robots can only tackle a small minority of the market.

Challenge 4: Need for mobility. All the current processes that involve mobility are not automated by robotics. This is because once there is a need for mobility, static robots simply cannot meet the requirements for the application.

In various embodiments, a robotic system as disclosed herein satisfies one or more of the following requirements:

Max Pallet Height Reach with >4 pallets: Static Robots today break the footprint requirement and are only limited to roughly 1.8 m in max pallet height, when requirements for the application are 2.4 m.

Footprint: Static robots roughly need 20-30 ft pitch between lanes/spurs to fit, however requirement needs solution to fit in existing 10-15 ft brownfield lane/spurs pitch.

Buffer Size: A buffer is needed to buffer boxes when dealing with the random sequence. Buffer size with a static robot is limited and may not be sufficient to dealing with the complex random sequence SKU mix in production.

Business Case: Even when all technical requirements check out, there are cases today where it does not pass the business case to install a fixed asset when the utilization of the application is low.

In various embodiments, a mobile robot as disclosed herein may be used for palletization, depalletization, loading and unloading into and out of pallets, pallet racking, rolling carts, gaylords, trays, totes, shelves, and other containers and may have one or more of the following capabilities and/or features:
The mobile robot can be used as a static robot, or in linear roving, or in autonomous free roaming throughout space. The autonomous free roaming robot can also travel up ramps to different levels within a building and elevators as needed.
The mobile robot has both a narrow and wide body fit, tailored in such a way that it can meet all application requirements while being able to fit anywhere a human can today (36″ inch walkway) and light enough to travel where a human can travel today (e.g. on elevated mezzanines).
The mobile robot can have one or many arms for item manipulation, collaboration, and self-support.
The mobile robot can safely interoperate with human operators in the same co-working environment. The robot will update its plans in response to the presence of a human by moving in a safe manner. The robot may be picking and placing to a multitude of locations, and a human may be inserting or retrieving receptacles/boxes or other objects from one or more of the locations. To ensure safety when working with or near the human, the robot selectively picks the boxes out of the buffer that enable it to pick-place on to a safe location that doesn't pose a risk of affecting the human's ongoing operation.
The mobile robot can act as a standalone system or together in a fleet. It can interoperate with other equipment, autonomous systems, humans, and humans operating equipment in the same co-working environment.

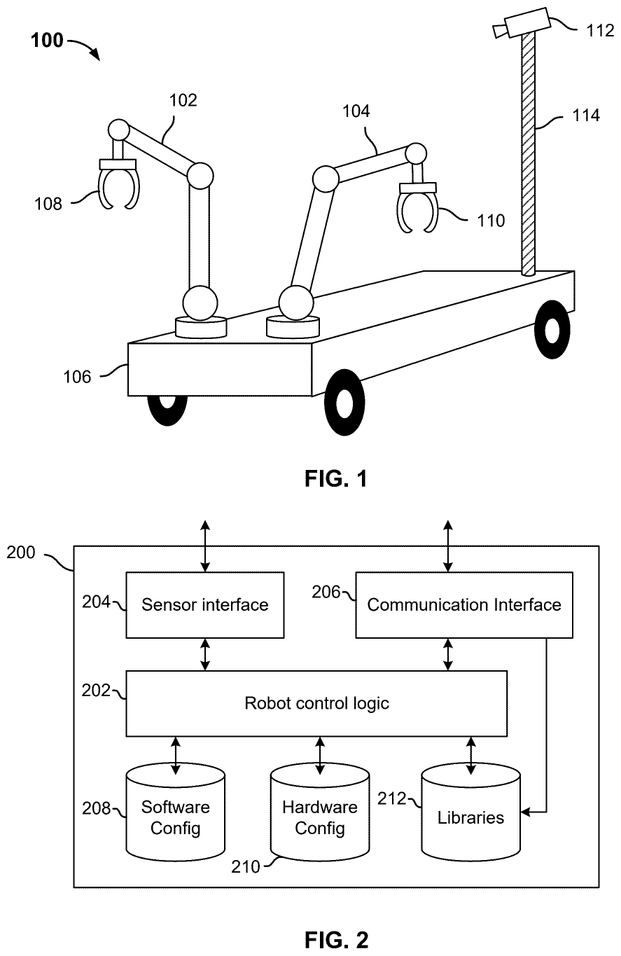

FIG. 1 is a diagram illustrating an embodiment of a multi-purpose robotic system. In the example shown, robot 100 includes robotic arms 102, 104 mounted near a front end of an autonomous or other mobile chassis 106. Mobile chassis 106 in this example has four independently driven and controlled wheels. The direction in which each wheel is pointed, the rotational direction in which it is driven, and the force, torque, speed, etc. at which each is driven are controlled for each wheel independently of the other three. In other embodiments, not shown, a drivetrain that includes fewer or no wheels may be used. For example, a drivetrain comprising two or more tracks, rollers, balls, or other alternatives to wheels may be used.

Each of the robotic arms 102, 104 is provided with an end effector 108, 110 to manipulate items. In this example, both end effectors 108, 110 are gripper type end effectors, however, any type of gripper may be used, and each of the robotic arms may be equipped with a different end effector, such as a suction type end effector, and/or any other tool or end effector. In various embodiments, robot 100 may be configured to reconfigure itself to perform a given task, including in various embodiments by changing the end effector 108, 110 mounted to a given robotic arm 102, 104; changing or removing one or both of the robotic arms 102, 104; repositioning a robotic arm 102, 104, e.g., by moving it to a different mounting location on the chassis 106; and/or mounting and supplying power, air, control signals, etc. to a modular auxiliary equipment, such as a fork lift or other attachment.

In the example shown in FIG. 1, a 3D (or other) camera 112 is mounted on a pole 114 mounted on chassis 106. In some embodiments, camera 112 may comprise a wireless camera or other sensor and/or may be mounted in the workspace and/or on another robot or other equipment than on chassis 106. In various embodiments, robot 100 uses image and/or depth information generated by camera 112 and/or one or more other sensors to generate and/or update a three-dimensional view of the workspace and/or portions thereof. In some embodiments, image and/or depth information generated by camera 112 and/or one or more other sensors may be used by another robot or another node, such as a remote or centrally located processing node, to generate and/or update a three-dimensional view of the workspace and/or portions thereof and to share/send data comprising the generated/updated three-dimensional view of the workspace with robot 100 and/or other robots. A computer vision or similar processing module may receive and merge image and/or other sensor data from a plurality of sensors to generate or update the view. Examples of such sensors include one or more of cameras or other (e.g., LIDAR) sensors mounted on robot 100, e.g., on a pole such as pole 114 and/or on a robotic arm 102, 104; cameras or other sensors mounted fixedly in a workspace in which robot 100 is operating; and/or cameras or other sensors mounted on or otherwise associated with another robot or other equipment working in the same area as robot 100.

In various embodiments, robot 100 uses a three-dimensional view of the workspace (or portion thereof) to perform work autonomously. The work may include pick and place operations performed to accomplish one or more objectives. The objectives may vary depending on the logistics related activity in which the robot has been configured to engage. For example, in various embodiments, software and/or hardware configurations of robot 100 may be changed depending on the robotic “application” the robot 100 is to perform at a given time. In the logistics context, examples of such robotic applications include, without limitation, truck or container loading/unloading; palletization or depalletization, e.g., from or to a conveyor or other destination; sortation and/or singulation, such as by picking items from one or more chutes and placing each singly in a corresponding location, such as a demarcated location on a segmented conveyor; and kitting or package assembly, e.g., picking a prescribed inventory of items each from an associated location to assemble a kit or package for shipment. In some embodiments, a hardware configuration change may include removing/adding one or more robotic arms, e.g., to provide a robot with one arm or more than two arms. In some embodiments, a robotic arm may be relocated to a different position on the chassis, according to a required hardware configuration. In some embodiments, a robot with just one arm may be provided and configured (e.g., positioned, provisioned with a selected gripper or other tool, etc.) according to the required hardware configuration.

In various embodiments, the software and/or hardware configuration changes required to transition robot 100 from performing one robotic application to instead performing a different application may be entirely or partly completed autonomously by robot 100 and/or may require manual intervention, e.g., by a human. In some embodiments, robot 100 may recognize the need to reconfigure and may initiate and/or implement the hardware and/or software configuration changes as/if needed. For example, a human user input or other indication may be received by robot 100 to begin a different set of tasks, or robot 100 may perceive that it has completed a first set of tasks and may request assignment of or assign to itself a new set of tasks requiring a different configuration.

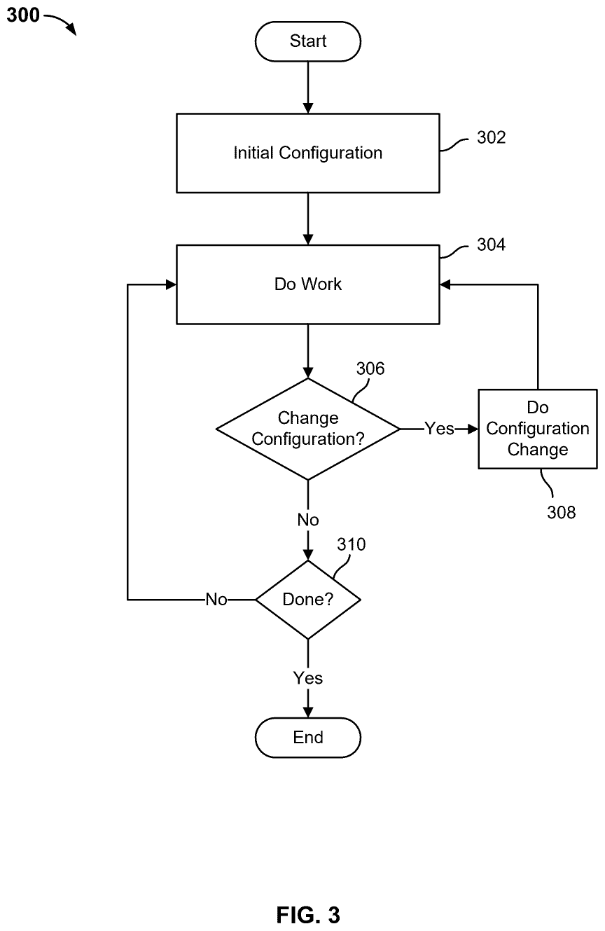

FIG. 2 is a block diagram illustrating an embodiment of a control module of a multi-purpose robotic system. In various embodiments, control module 200 of FIG. 2 is included in a multi-purpose robotic system, such as robot 100 of FIG. 1. For example, control module 200 may be embodied in and/or implemented by one or more processors, circuit boards, and/or other structures contained within or mounted on chassis 106.

In the example shown, control module 200 includes robot control logic 202 which controls a robot, such as robot 100, based on image and/or other sensor data received via a sensor interface 204 and via communications received and/or sent, e.g., to a central or other higher level control computer, one or more other robots, and/or robotic arms (e.g., robotic arms 102, 104), end effectors (e.g., end effectors 108, 110), sensors (e.g., camera 112), and/or other robotic elements via communication interface 206. In various embodiments, communication interface 206 may include an ethernet, etherCAT, and/or other wired or wireless network interface.

In various embodiments, robot control logic 202 uses software configuration data 208 and hardware configuration data 210 to perform a set of tasks, e.g., tasks associated with a given robotic application the robot is currently assigned and/or configured to perform. To change configurations, e.g., to prepare itself and/or be prepared by a human operator to perform a different robotic application (e.g., to change from depalletization to truck unloading), in various embodiments, the robot control logic 202 and/or other logic may update one or both of the software configuration data 208 and hardware configuration data 210, e.g., by loading libraries of robotic control primitives, strategies, heuristics, etc. from stored libraries 212.

Libraries 212 may include a list or other inventory of software and/or hardware configurations that must be loaded and/or installed to perform a given robotic application. Robot control logic 202 may compare the current configuration to the required configuration and update one or both of the software configuration data 208 and hardware configuration data 210 accordingly. If hardware changes are required, e.g., a new end effector must be installed, etc., the robot control logic 202 may cause the change to be made autonomously, if able, and/or may invoke human intervention to make or help make a change. For example, the robot control logic 202 may include logic to drive the robot to a end effector changeout location, unmounted a current end effector, and mounted the required end effector. Human intervention may be required to complete a change, such as by connecting a wire or air hose, etc.

In various embodiments, robot control logic 202 and/or other logic may be configured to learn, by applying machine learning techniques, new or updated strategies to use hardware equipment comprising the robot to perform a task. For example, a robot may use a variation on a previously learned or configured strategy to grasp a box from the top row of a wall of boxes, e.g., boxes that had been loaded into and transported in a truck or other container and which are being unloaded at a distribution center by the robot, determine the new strategy was successful, and update its libraries 212 to include the new strategy as a strategy available to be used to perform the same or similar tasks in the future.

In some embodiments, a robot may observe as a human intervenes to assist the robot, e.g., via teleoperation of the robot and/or a robotic arm comprising the robot and may learn by observing the human a strategy that may be useful in the future. For example, a human may operate the robot to use a first robotic arm and its end effector to hold a lower box or boxes in place as the human operates a second robotic arm to grasp and pull out a box or other item stacked on top of the lower box or boxes. The robot may learn the technique, through observation, and update its libraries 212 accordingly.

In various embodiments, libraries 212 may be updated via communications sent and/or received via communication interface 206. For example, another robot may have learned a new strategy to grasp, translate, and/or place a given item or type of item and may have updated its local library accordingly. The update may have been communicated to a central node and/or directly to the robot with which control module 200 is associated, resulting in an update to libraries 212 being received via communication interface 206. Likewise, new techniques learned by a robot with which control module 200 is associated may be communicated to a central repository and/or directly to other robots via communication interface 206.

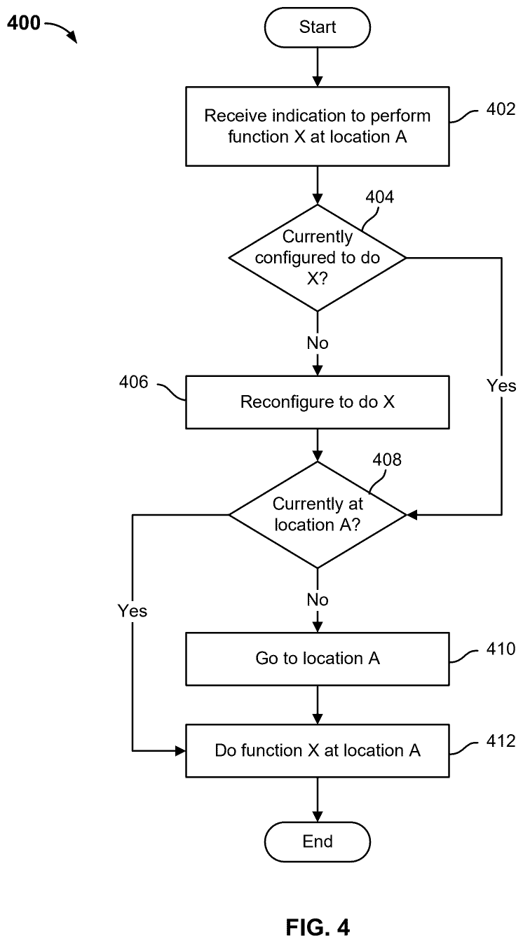

FIG. 3 is a flow diagram illustrating an embodiment of a process to configure a multi-purpose robotic system as/if needed to perform work. In various embodiments, the process 300 of FIG. 3 may be implemented and/or performed, in whole or in part, by one or both of a robot control module, such as control module 200 of FIG. 2, and/or one or more other elements comprising a multi-purpose robotic system, such as robot 100 of FIG. 1.

In the example shown, at 302 a robot comprising a multi-purpose robotic system starts in an initial (e.g., current or most recent) configuration. The configuration may include one or both of a software configuration and a hardware configuration. At 304, the robot does work associated with the current configuration, e.g., palletization, truck unloading, singulation, sortation, or kitting. At 306, if an indication is received to change configuration, a configuration change is performed at 308, after which the robot resumes doing work at 304, but under the new configuration. For example, at 306, an indication may be received that a truck or container unloading task is completed, e.g., the robot sees that the truck or container is empty, resulting in the robot being assigned to do other work, such as to pick items from a conveyance structure to which another robot has placed items while unloading another truck, and place them each in a corresponding pallet or other receptacle or other destination. In such a case, at 308 the robot may implement, initiate, and/or receive software and/or hardware configuration changes as/if needed to perform the new work, prior to starting the new work at 304.

The robot continues to do work (304), changing configuration as/if needed (306, 308), until an indication is received at 310 that all work is done, upon which the process 300 ends.

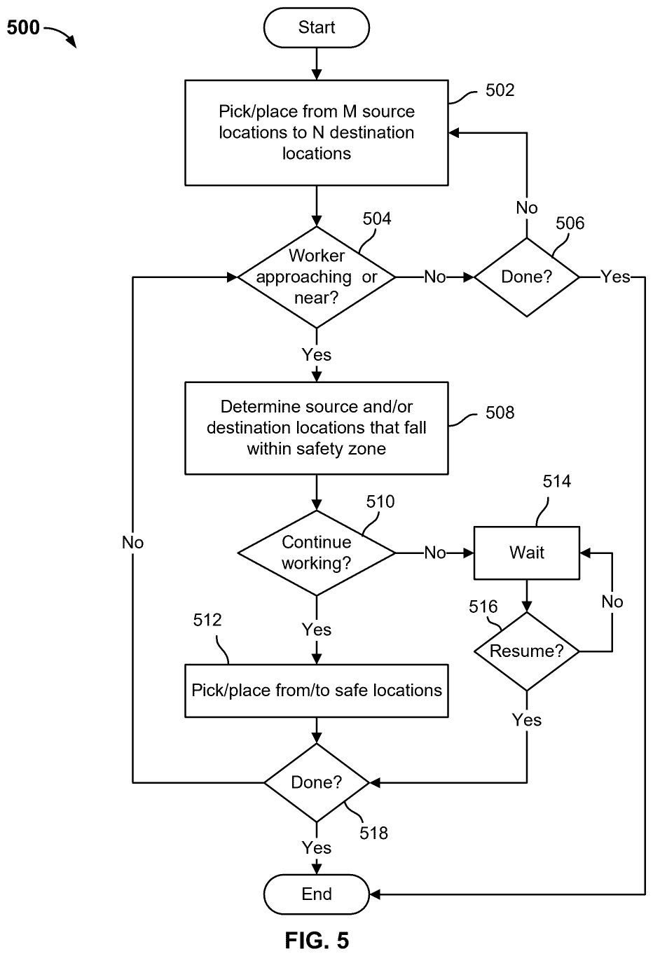

FIG. 4 is a flow diagram illustrating an embodiment of a process to configure and/or reposition a multi-purpose robotic system as/if needed to perform work. In some embodiments, process 400 of FIG. 4 is used to implement step 308 of FIG. 3. In some embodiments, process 400 of FIG. 4 is implemented by a control module, such as module 200 of FIG. 2 and/or one or more other elements comprising a multi-purpose robotic system, such as robot 100 of FIG. 1. In the example shown, at 402 an indication is received to perform function X (associated, e.g., with a specific robotic application) at location A (e.g., a workstation in a logistic center, such a warehouse, specific bay in a loading dock, etc.). At 404, it is determined whether the robot is currently configured to do function X. If not, at 406 the robot is reconfigured as needed to perform function X. For example, software and/or hardware configurations may be changed.

At 408, it is determined whether the robot is currently at location A. If not, at 410 the robot relocates to location A, e.g., via autonomous navigation. Once properly configured and at the correct location, at 412 the robot performs function X at location A.

While for clarity process 400 of FIG. 4 shows the configuration check/change and location confirmation/relocation being done sequentially, in various embodiments they may be done wholly or partially in parallel. For example, the robot may update its software configuration to do X as it transits to location A. Or the robot may first transit to a hardware configuration station to update its hardware configuration prior to continuing on to location A.

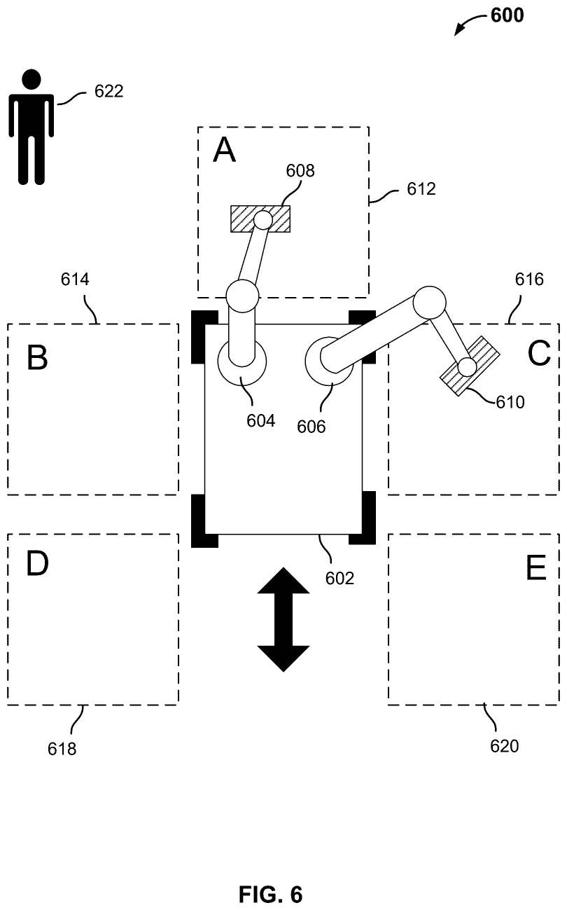

FIG. 5 is a flow diagram illustrating an embodiment of a process for a multi-purpose robotic system to work safely with other human or robotic workers. In various embodiments, process 500 is implemented by a control module, such as module 200 of FIG. 2 and/or one or more other elements comprising a multi-purpose robotic system, such as robot 100 of FIG. 1. In the example shown, at 502 the robotic system picks/places items from M source locations to N destination locations, depending on the logistics related robotic application it has been configured to perform. For example, the system may pick from one or more pallets and place items on a conveyor or each to a selected outbound pallet, box, or other receptacle. Work continues if no human (or other robotic) worker is approaching or near (504, 506).

If, at 504, an indication is received that a human (or other robotic) worker is approaching or near, then at 508 a determination is made as to which, if any, of the source locations M and/or destination locations N fall within a safety zone associated with the human or other worker's location and/or speed and direction of travel, if moving. If at least one of the source locations M and one of the destination locations N remains safe to perform robotic operations (510), then the robot continues working while limiting itself to those safe locations (512). If no location is outside the safety zone associated with the human/other worker (510), the robot waits (514) until it is safe to resume work (516).

Work continues until all work is done (506, 518), upon which process 500 ends.

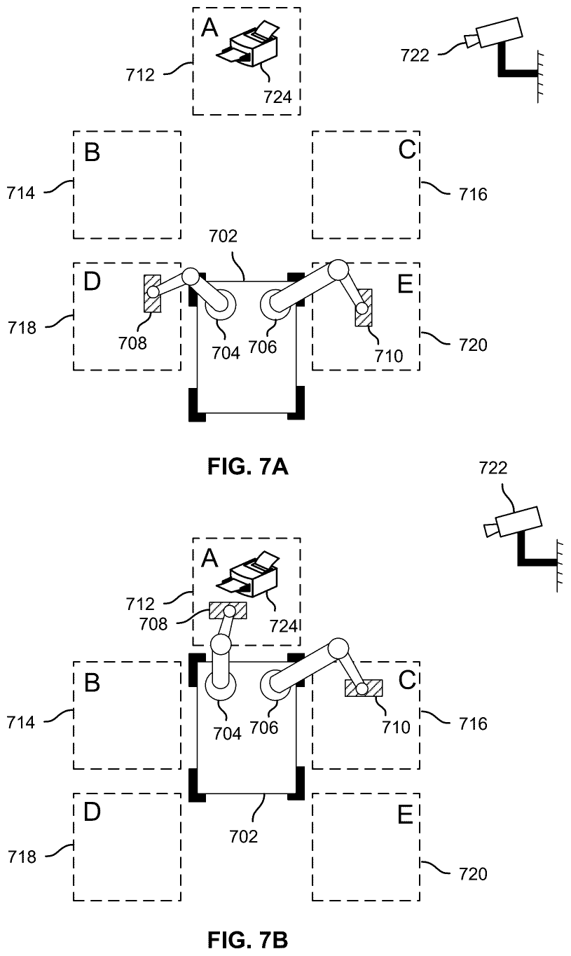

FIG. 6 is a diagram illustrating an embodiment of a multi-purpose robotic system configured to pick and place items safely in the presence of a human worker. In the example shown, robotic system and environment 600 includes a multi-purpose robotic system comprising a mobile chassis 602 on which robotic arms 604, 606 having end effectors 608, 610 are mounted. In various embodiments, the multi-purpose robotic system 602, 604, 606, 608, 610 is configured to pick/place items (not shown for clarity) between source and/or destination locations 612, 614, 616, 618, 620 arranged in this example as shown in FIG. 6.

For example, location A may comprise one or more chutes or other conveyance structures configured to supply a flow of mixed items to a pick area near the multi-purpose robotic system 602, 604, 606, 608, 610 as shown. Items picked from location A may be placed each in a corresponding one of the destination locations B, C, D, and E. In another example, location A may comprise a source pallet that has been placed at location A, e.g., after having been unloaded from a truck or other transport vehicle and/or retrieved from a storage location in a warehouse, while locations B, C, D, and E may each have one or more destination pallets, boxes, or other receptacles located therein. The robot may pick items from the pallet at location A and place each item in a destination pallet or other receptacle in locations B, C, D, and/or E. In yet another example, items may be picked from pallets or other receptacles at locations D and E and placed in destination receptacles in locations A, B, and/or C. Or items may be picked from a conveyor or other material handling structure not shown in FIG. 6, e.g., off the bottom of the page, and each item placed in a corresponding location at one of the locations A, B, C, D, or E. Etc.

In the example shown, a human worker 622 is present and/or approaching. In various embodiments, a camera or other sensor, not shown in FIG. 6, may be used to detect the human 622 and/or determine their direction and speed of motion. Based on the location and/or direction and speed of motion, one or more of the locations A, B, C, D, and E may be determined to be unsafe to conduct robotic operations. For example, in the example shown, it may be determined that it would be unsafe for human 622 to conduct robotic operations at locations A, B, and D. It may also be determined to be unsafe to operate robotic arm 604. In various embodiments, the robot would configure itself to continue operation while limiting itself to using robotic arm 606 to pick/place items between just locations A, C, and E, at least until the human 622 is no longer present.

In various embodiments, the multi-purpose robotic system 602, 604, 606, 608, 610 of FIG. 6 picks/places items between source and/or destination locations A, B, C, D, and E at least in part by moving fore and/or aft (up or down in the page as shown), as indicated by the double headed arrow in FIG. 6, as/if needed to reach pick/place locations within locations A, B, C, D, and E. For example, an item may be picked from a pick site in location A using robotic arm 606 and end effector 610 and moved through a trajectory that is realized in part by manipulating the elements comprising robotic arm 606 and in part by driving the chassis 602 in the direction of location E (i.e., in the direction of the downward part of the double headed arrow, as shown). By contrast, a prior art palletization, singulation, or kitting robot typically would remain stationary while picking/placing items, limiting the number and/or variety of source and/or destination locations that could be reached by the robot.

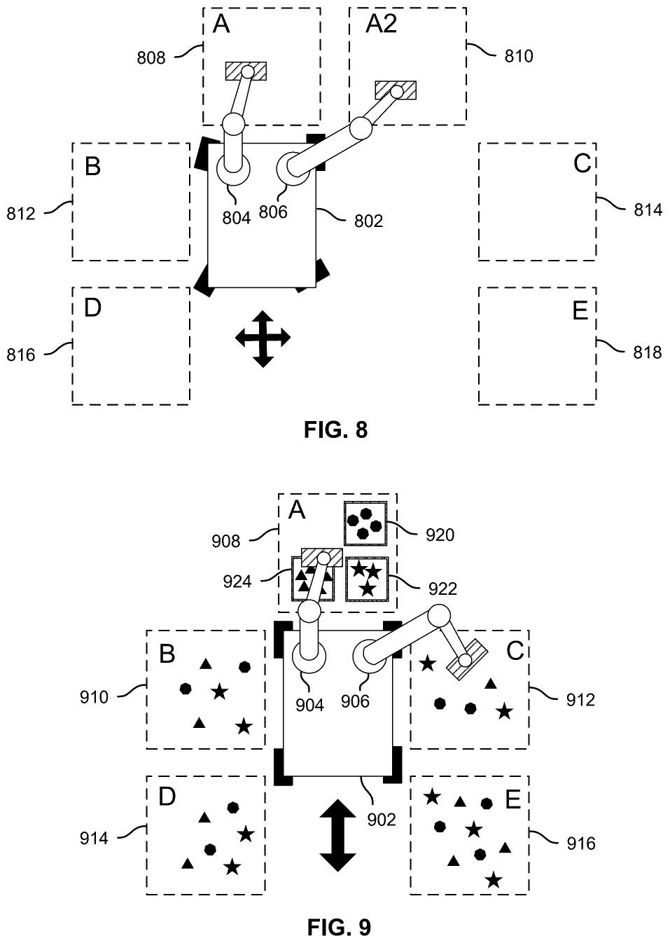

FIGS. 7A and 7B illustrate an embodiment of a multi-purpose robotic system configured to pick, label, and place items. In the example shown, a robot comprising mobile chassis 702, robotic arms 704, 706, and end effectors 708, 710 is configured to pick items from locations such as D (718) and E (720); carry them to a labeling station at location A (712) and use labeling equipment at location A to affix a label, such as a shipping label; and place each item in a corresponding placement site at location B (714) or C (716). The robot moves nearer to or further from location A (i.e., in the y-direction as shown) as needed to pick, label, and place items.

In various embodiments, the robot uses data from camera/sensor 722 to determine a downstream delivery destination for an item in its grasp, such as delivery address. The robot and/or other elements comprising the multi-purpose robotic system of which the robot is an element causes the labeling equipment at location A to print a label for an item in its grasp, then navigates to a position near location A and uses its robotic arm 704, 706 and/or end effector 708, 710 to manipulate the item as needed to cause the label to be affixed to the item. For example, the labeling equipment may expose the adhesive of at least one edge of the label, and the robot may press the item to the adhesive at the exposed edge, then move the item laterally to cause the adhesive side of the label to become more completely engaged mechanically with and adhere to the item. Once the label has been verified to have been affixed to the item successfully, the item is placed in a destination site at location B or C, such as an outbound pallet or other receptacle and/or an outbound conveyance or other material handling equipment associated with the ultimate downstream destination on the label. For example, items being shipped to destinations west of the distribution center may be placed on conveyor or chute B while items bound for eastern destinations may be placed on conveyor or chute C.

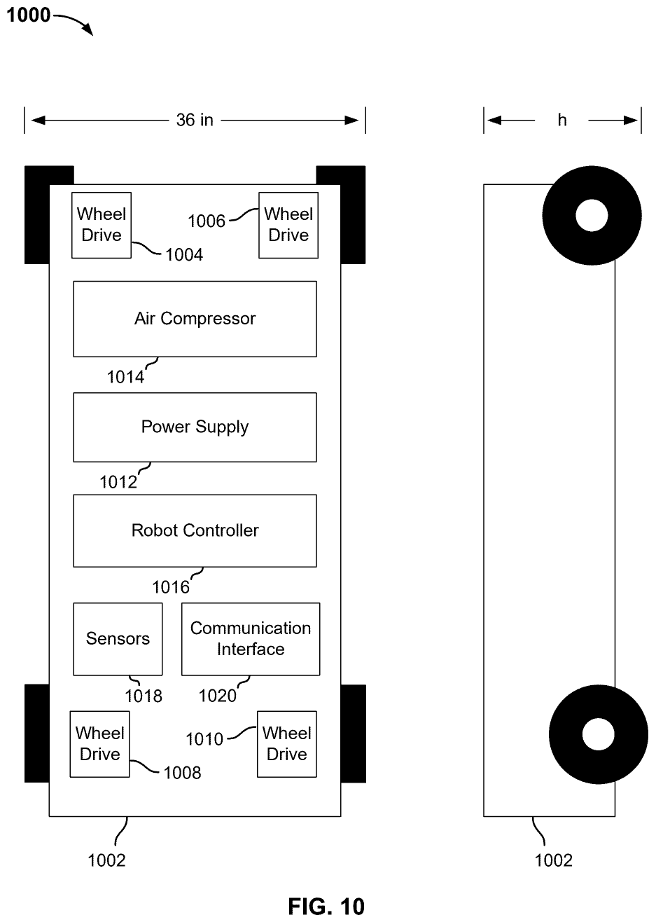

FIG. 8 illustrates an embodiment of a multi-purpose robotic system configured to pick and place items, including by moving freely in x-y space. In the example shown, a robot comprising mobile chassis 802 and robotic arms 804, 806 is positioned in an area bounded by pick/place locations 808, 810, 812, 814, 816, and 818, denominated locations A, A2, B, C, D, and E, respectively. The robot includes four independently controlled and driven wheels, enabling the robot to move in any direction in the x-y area bounded by locations A, A2, B, C, D, and E, at an orientation and via any path. For example, items may be picked from sites in locations A and A2 and moved to and placed at placement locations in locations B, C, D, and/or E. In one robotic application, locations A and A2 may comprise chutes or conveyors via which mixed items arrive. The robot may pick items, identify them, determine a placement site, move as needed toward the location of the placement site, and place the item in the placement site. Various of the foregoing steps may be performed simultaneously and/or in any order. For example, the item may be identified and its placement site determined prior to the item being picked.

In various embodiments, a trajectory may be planned that includes moving an item through three-dimensional space from a pick site to a placement site including by operation a robotic arm 804, 806, and moving the mobile chassis 802 through a trajectory comprising a sequence of locations and poses (orientations). For example, starting from a position as shown in FIG. 8, robotic arm 804 may be assigned to pick an item from location A (808), and a trajectory may be planned to move the item and place it at a placement site in location E, e.g., by rotating the chassis 802 ninety degrees about a z-axis of chassis 802 while moving the chassis through an arc such that the chassis 802 and robotic arms 804, 806 are on a side facing (i.e., most nearly adjacent to) the leftmost edge of location E. Alternatively, for example if needed to (better) avoid an obstacle and/or to end up in a more advantageous pose to perform a next planned pick/place, the orientation of chassis 802 may be maintained and the chassis 802 moved nearer to location E by first moving laterally along the bottom edges of locations A and A2 then moving back along the left edges of locations C and E. (Note robotic arm 806 may be selected for use, instead of robotic arm 804, to facilitate placement in location E from the starting pose/orientation.) Or a further option would be to control and drive the wheels in a manner to cause the chassis to move with the starting orientation along a diagonal path from the starting position as shown directly to a position alongside location E. The possibilities are not limited. The specific manner to control the chassis 802 and robotic arms 804, 806 may be determined by generating one or more plans and selecting the plan with the best “score” or lowest “cost” as defined by the robot's configuration.

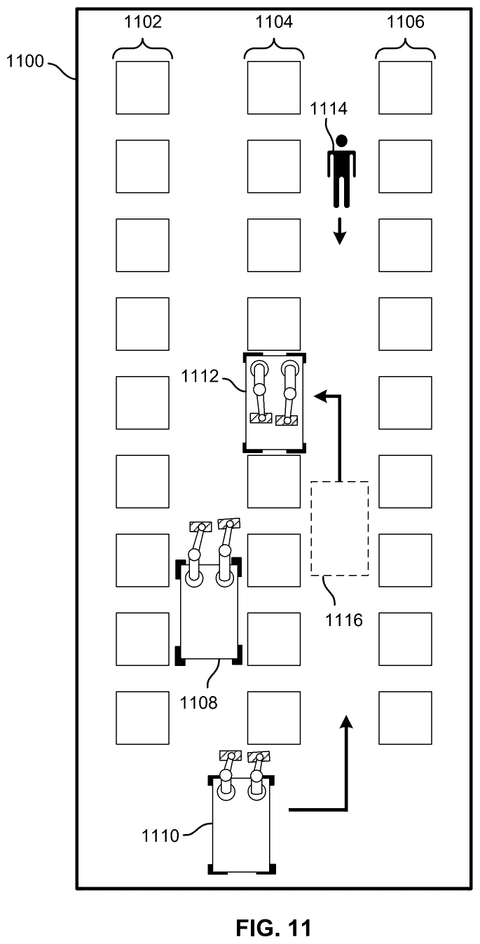

FIG. 9 illustrates an embodiment of a multi-purpose robotic system configured to pick and place items to perform sortation and/or kitting operations. In the example shown, a robot comprising mobile chassis 902 and robotic arms 904, 906 is positioned to pick/place items between locations 908, 910, 912, 914, and 916, also denominated as locations A, B, C, D, and E, respectively. In this example, mixed items are positioned in locations B, C, D, and E, while items in location A are sorted by type in bins or other receptacles 920, 922, and 924. For example, the system of FIG. 9 may be configured to fulfill orders by drawing from source bins 920, 922, and 924 in location A to build the mixed item collections shown in locations B, C, D, and E, which may be boxes, pallets, or other receptacles each bound for a different destination. Conversely, mixed items in locations B, C, D, and E may be sorted by the robot into separate bins 920, 922, and 924 in location A. For example, locations B, C, D, and E may be mixed pallets of items, or a chute or other conveyance via which mixed items are arriving.

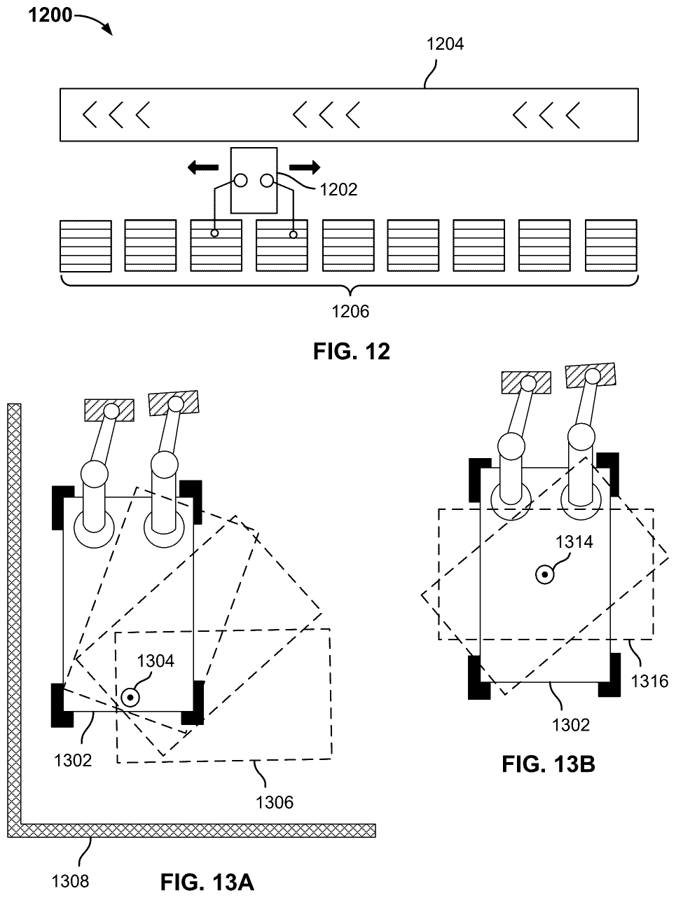

FIG. 10 is a block diagram illustrating an embodiment of a multi-purpose robotic system having a novel form factor. In various embodiments, the chassis 1002 to the multi-purpose robotic system 1000 of FIG. 10 corresponds to the chassis 106, 602, 702, 802, and/or 902 of FIGS. 1, 6, 7A and 7B, 8A and 8B, and 9. In the example shown, the chassis 1002 has a wheel base (i.e., effective maximum width) of 36 inches (or less, in some embodiments), enabling the chassis 1002 to enter and transit through lanes of a width that may have been designed or intended only for a human worker to pass through. The side view at right shows that the height of the chassis 1002 above ground (i.e., the bottom of the wheels) is h inches, which in various embodiments is designed to enable the robot 1000 to be driven and, in some embodiments, operate from beneath a material handling structure, such as a conveyor.

In various embodiments, as in the example shown in FIG. 10, the narrow and low profile (i.e., height) form factor is achieved at least in part by arranging elements in an inline arrangement. In other embodiments, elements comprising the robot 1000 may be nested, stacked, and/or inline, or arranged in some other configuration to fit the required elements into a chassis having the desired width and height to be able to operate in narrow spaces and/or beneath material handling equipment or other structures.

Referring further to FIG. 10, in the example shown the robot 1000 includes within chassis 1002 independently controlled wheel drive control modules and electromechanical mechanisms 1004, 1006, 1008, and 1010, enabling the direction (in which the wheel is pointed), rotation (i.e., whether wheel rotates forward or back), and speed of each wheel to be controlled independently of all the other wheels. The chassis 1002 further houses, in an inline arrangement as shown, a power supply 1012 (e.g., one or more batteries and power electronics) configured to provide power to an air compressor 1014, which supplies are to operate suction-type end effectors and/or other tools, in various embodiments, and robot controller 1016 (e.g., controller 200 of FIG. 2), in addition to providing power to the wheel drives 1004, 1006, 1008, 1010. Sensors 1018 (e.g., cameras, LIDAR, other sensors) and communication interface 1020 also are mounted on and/or housed within the chassis 1002.

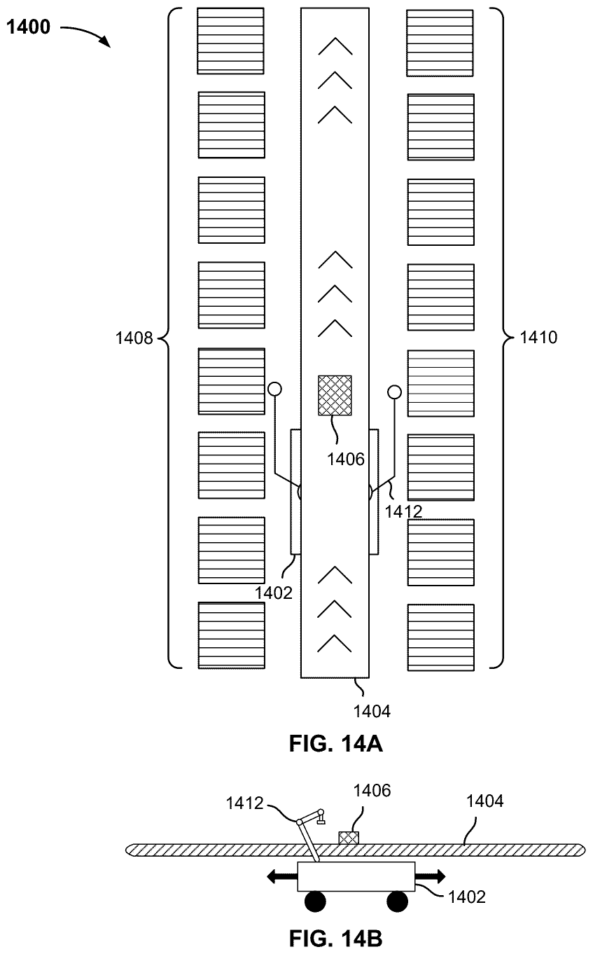

FIG. 11 illustrates a multi-purpose robotic system comprising a plurality of multi-purpose mobile robots operating safely in an environment in which a human worker is present. In the example shown, distribution center 1100 includes a plurality of pick/place locations (e.g., pallets, bins, shelves, or other receptacles) arranged in columns 1102, 1104, 1106 in this example. A plurality of mobile robots 1108, 1110, 1112 operate within the distribution center 1100. For example, robots 1108, 1110, 1112 may carry items in their robotic arms and/or placed on their chassis and may navigate to various locations in distribution center 1100 to place items in receptacles, e.g., to restock shelves, build kits or pallets, etc. Or robots 1108, 1110, 1112 may navigate to various locations in distribution center 1100 to retrieve items required elsewhere, e.g., to load into a truck or onto a pallet, etc.

In the example shown in FIG. 11, a human worker 1114 entered the aisle between locations 1104 and 1106 and proceeded towards robot 1112 when it was in the same aisle, in the position indicated by dashed lines 1116. In response to detecting and/or being alerted to the presence and approach of human worker 1114, robot 1112 made and acted on a plan to navigate into and remain in the location as shown, which is a gap between placement locations in column 1104, to allow human worker 1114 to pass safely by and leave the area prior to robot 1112 resuming its work. For example, robot 1112 may have advanced to a position alongside the recess in which it is shown in FIG. 11 and then used its independently controlled drive wheels to move laterally into the recess. In various embodiments, robots operating in a work area, such as distribution center 1100, may be configured to know the location of spaces reserved for robots to recede into a wait while a human safely passes, better enabling humans and robots to work together in areas that may have been intended initially only for human workers to access.

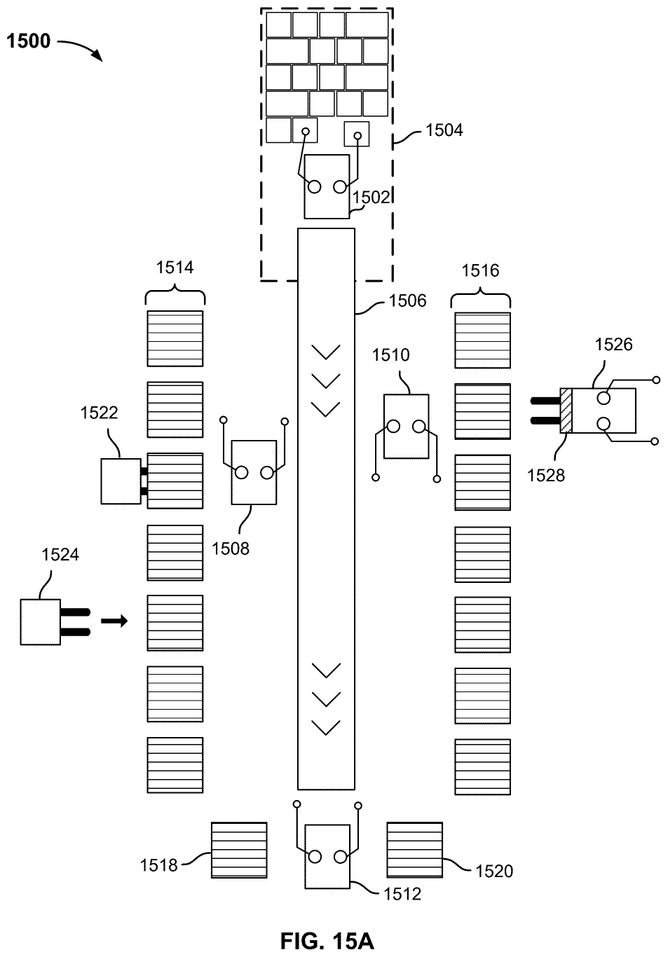

FIG. 12 illustrates a multi-purpose robotic system configured to pick/place items, including by moving laterally alongside a conveyance structure and a row of pallets or other receptacles. In the example shown, workspace 1200 includes a robot 1202 configured to move laterally in a lane defined by conveyor 1204 and placement locations 1206 arranged in a line running parallel to the conveyor 1204. In various embodiments, depending on the robotic application it is configured to perform, robot 1202 may pick items from conveyor 1204 and place each in a corresponding one of the locations 1206, e.g., a corresponding pallet, bin, gaylord, or other receptacle, e.g., for sortation, kit or pallet building, etc., or, alternatively, robot 1202 make pick items from locations 1206 and place them on conveyor 1204, e.g., to load a truck or container from items on pallets at locations 1206. In various embodiments, the arrangement shown in FIG. 12 may facilitate work by other human and/or robotic workers, such as autonomous mobile robots (AMR) configured to deliver and/or remove pallets from locations 1206.

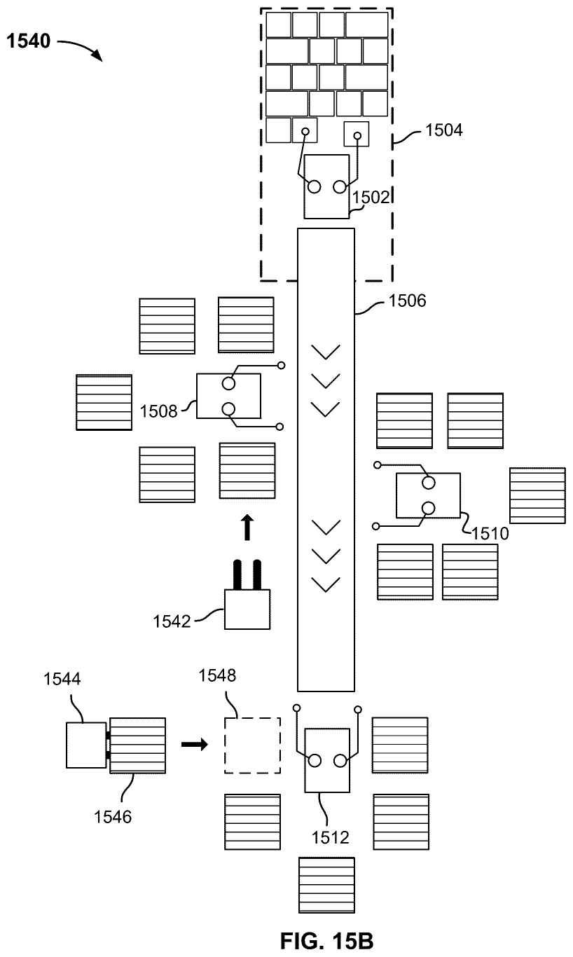

FIGS. 13A and 13B illustrate a multi-purpose robotic system capable of pivoting about an arbitrary vertical (e.g., z-) axis. In the example shown in FIG. 13A, robot 1302 uses its independently controlled wheels to rotate about a vertical axis 1304 near the rear of the robot 1302 to a new pose/position 1306, enabling the robot to change its orientation by ninety degrees within an area constrained by walls 1308 and/or other obstacles. In the example shown in FIG. 13B, the same robot 1302 uses its independently controlled wheels to rotate about a different vertical axis 1314 to a new pose/position 1316, demonstrating the ability to turn to any direction while remaining within a circumscribing circle defined by its wheelbase and length.

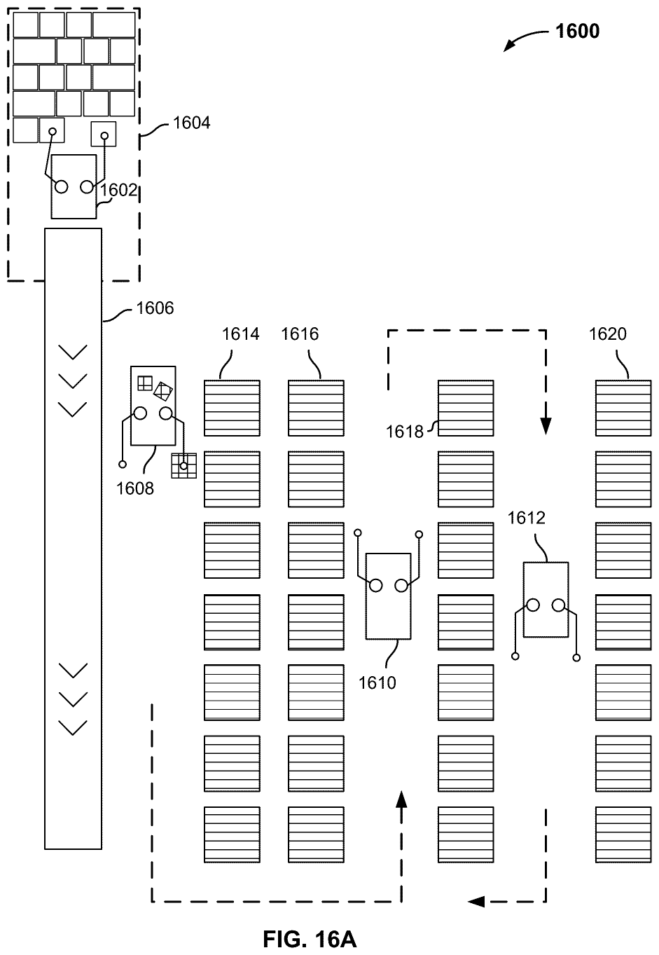

FIGS. 14A and 14B illustrate a multi-purpose robotic system configured to operate beneath a conveyance structure, picking/placing items between the conveyance structure and adjacent pallets or other receptacles. In the example shown, workspace 1400 includes a robot 1402 positioned to move fore and aft beneath a conveyor 1404, using its robotic arms (e.g., 1412) to reach up and around conveyor 1404, from either side, to pick/places items, such as box 1406, from/to the upper surface of conveyor 1404. For example, robot 1402 may pick items from pallets or other receptacles positioned in locations 1408, 1410 along either side of conveyor 1402 and place each on the upper moving surface of conveyor 1402 or, alternatively, robot 1402 may pick items from the upper moving surface of conveyor 1402 and place each item in a corresponding pallet or other receptacle positioned in one of the locations 1408, 1410 along either side of conveyor 1402.

In various embodiments, providing a robot, such as robot 1402, that can operate from beneath a conveyor, such as conveyor 1404, enables a large number of source/destination locations 1408, 1410 to be positioned in less space, since the source/destination locations 1408, 1410 can be much nearer the conveyor 1404 than would be possible if it were necessary to leave room on either side of the conveyor for a robot to operate and transit. In addition, a single robot 1402 can load/unload from/to both sides of conveyor 1404.

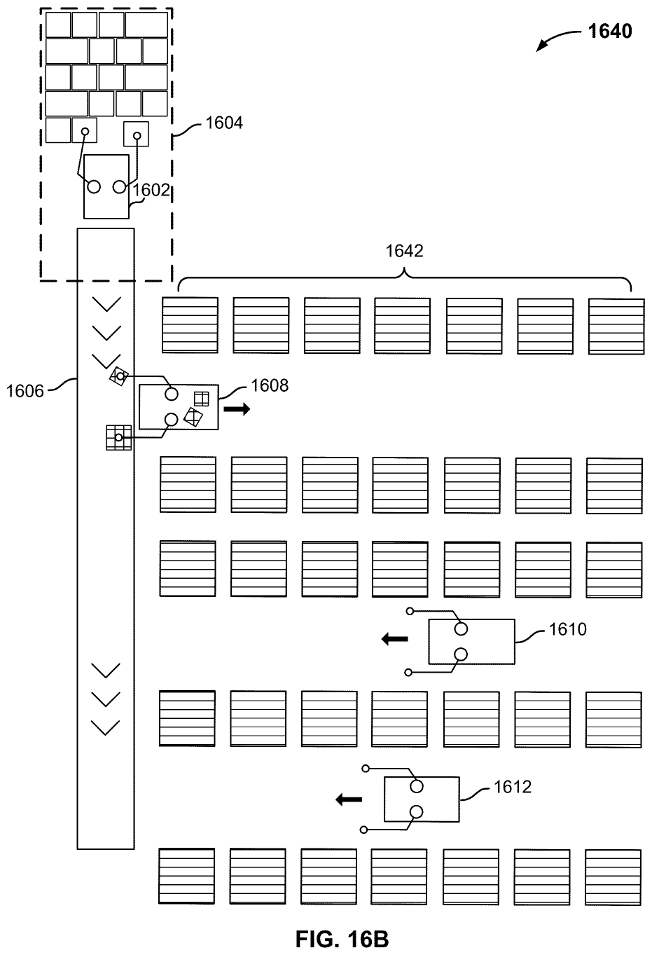

FIGS. 15A and 15B illustrate a multi-purpose robotic system comprising a plurality of multi-purpose mobile robots cooperating to load/unload a truck or other container, including by picking/placing items to/from a conveyance structure configured to convey items between the truck or other container and sets of pallets or other receptacles located near the conveyance structure.

In the example shown in FIG. 15A, workspace 1500 includes robot 1502 operating within a truck or container 1504, e.g., to unload boxes or other items from truck or container 1504. A conveyor or other material handling equipment 1506 has been extended into truck or container 1504. For example, robot 1502 may have towed conveyor 1506 into truck or container 1504, e.g., an expandable conveyor, and/or may have caused or controlled another robotically controlled instrumentality to extend the conveyor 1506 into the truck or container 1504, e.g., a telescoping or otherwise extendable conveyor. In various embodiments, the conveyor or other material handling equipment 1506 may be positioned behind, over, and/or to the side of robot 1502.

In the example shown in FIG. 15A, robots 1508, 1510, and 1512, located outside of truck or container 1504, are configured and positioned to pick items from conveyor 1506 and place each in a corresponding location, e.g., pallets or other receptacles in positions 1514, 1516, 1518, and/or 1520. Computer vision and/or other sensors may be used to identify each item and its destination (i.e., placement location). Robot 1508 may pick from conveyor 1506 items destined for pallets or other receptacles 1514, which robot 1510 may pick from conveyor 1506 items destined for pallets or other receptacles 1516, leaving items destined for locations 1518 or 1520 to be picked by robot 1512. The motion of conveyor 1506 may be controlled to ensure items are able to be picked by the appropriate robot 1508, 1510, or 1512. Auxiliary robots 1522 and 1524, e.g., autonomous mobile robots (AMR), are shown operating to remove full pallets or other receptacles and/or to place new empty (or partially loaded) pallets or other receptacles at locations 1514, 1516, 1518, and/or 1520 as needed. A helper multi-purpose robot 1526 is shown with a forklift or other modular material handling attachment 1528 mounted to assist with the removal of loaded pallets/receptacles and/or placement of new pallets/receptacles.

While the above example describes robots 1502, etc. being used to unload items from truck or container 1504, the same equipment as shown in FIG. 15A may be used in various embodiments to load truck or container 1504. For example, robots 1508, 1510, and 1512 may be used to pick items from pallets or other receptacles at locations 1514, 1516, 1518, and/or 1520 and place each on conveyor 1506 to be carried into truck or container 1504 for loading by robot 1502. Robot 1502 may pick items from the end of conveyor 1506 that extends into truck or container 1504 and stack them densely in truck or container 1504, for example by building successive walls of boxes, as the robot 1502 and conveyor 1506 back out (or are backed out) as needed to build the next wall.

Referring next to FIG. 15B, workspace 1540 includes the same robots 1502, 1508, 1510, 1512; truck or container 1504; and conveyor 1506, but the pallets/receptacles are arranged differently in proximity to each of the robots working outside the truck or container 1504. Specifically, the pallets or other receptacles are arranged as shown, for example, in FIG. 6. To unload, robot 1502 places items on conveyor 1506. Robots 1508, 1510, and 1512 located outside the truck or container 1504 each picks selectively from the conveyor 1506 items destined for a pallet or other receptacle arranged near that robot and moves forward/backwards in the lane that extends perpendicularly to the conveyor 1506 to move as needed to a position from which the robot can place the item in its destination location. In this example, AMRs 1544, 1544 may approach pallets (or other receptacles) from different approaches and/or orientations, as needed to remove full pallets (or other receptacles) and/or place empty (or partially full) pallets (or other receptacles).

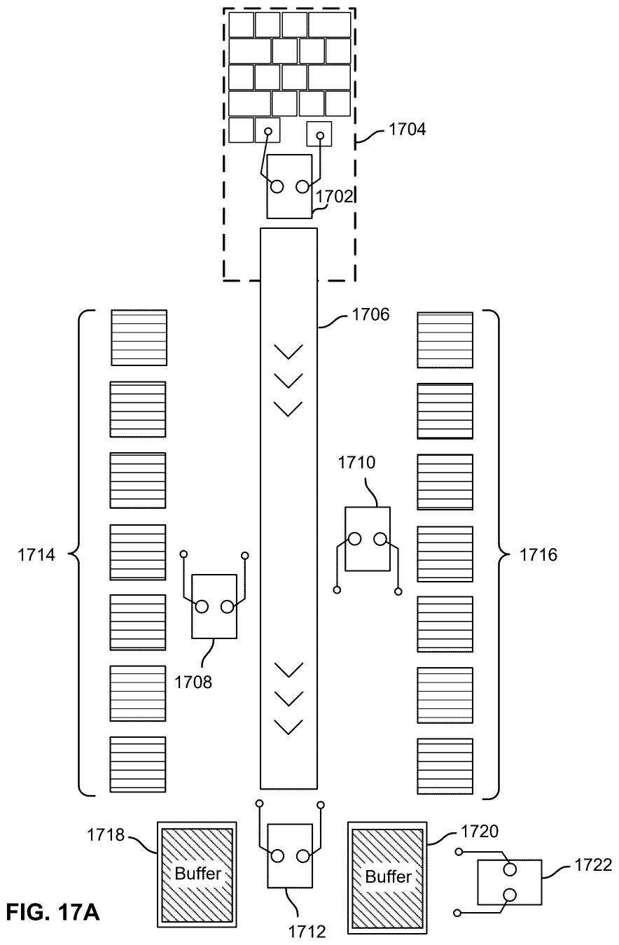

FIGS. 16A and 16B illustrate a multi-purpose robotic system comprising a plurality of multi-purpose mobile robots cooperating to load/unload a truck or other container, including by picking/placing items to/from a conveyance structure configured to convey items between the truck or other container and sets of pallets or other receptacles arranged in rows and/or columns. While in the examples shown in FIGS. 15A and 15B the robots operating outside the truck or container 1504 remain relatively near to conveyor 1506, in the examples shown in FIGS. 16A and 16B the robots that work outside the truck or conveyor roam up/down lanes defined by rows or columns of placement locations. In various embodiments, such an approach enables a larger number of placement locations to be provided and used at the same time.

Referring first to FIG. 16A, workspace 1600 includes robot 1602 positioned in truck or container 1604. Conveyor 1606 extends into truck or container 1604, enabling robot 1602 to be used to load or unload items from truck or container 1604. Robots 1608, 1610, and 1612 outside of truck or container 1604 roam up and/or down lanes defined by pallets or other receptacles placed in rows (or columns) 1614, 1616, 1618, and 1620.

To unload, for example, robot 1602 picks items from within truck or container 1604 and places each on conveyor 1606, which carries each item out of truck or container 1604 to a position from which one of the robots 1608, 1610, and 1612 working outside of truck or container 1604 can pick the item, roam to the pallet or other receptacle on or in which it is to be placed, and place the item.

To load items onto/into truck or container 1504, robots 1608, 1610, and 1612 may roam among the pallets or other receptacles to find and pick a next one or more items to be loaded (e.g., according to a loading plan, manifest, etc.), roam to a position alongside conveyor 1506, and place the item on conveyor 1606, which carries the item into truck or container 1604 where robot 1602 picks the item from conveyor 1606 and places the item in a corresponding location in truck or container 1604.

As shown in FIG. 16A, robots working outside the truck or container 1604 may carry items to/from pallets or other receptacles in the grasp of one or both (or more) of their robotic arms and/or may carry items by placing them on their chassis, e.g., according to each item's size, weight, fragility, and/or other attributes.

Referring now to FIG. 16B, workspace 1640 is shown to include the same robots 1602, 1608, 1610, and 1612; truck or container 1604; and conveyor 1606 as in FIG. 16A. However, in workspace 1640, pallets or other receptacles 1642 are arranged in rows that extended perpendicular to conveyor 1606, defining lanes extending perpendicular to conveyor 1606 via which robots 1608, 1610, and 1612 transit as needed to pick/place items to/from pallets or other receptacles along either side of the lane in which each is positioned and operating.

In various embodiments, human intelligence, generative artificial intelligence, and/or a combination may be used to determine the layout of pallets or other receptacles for a given operational situation, e.g., to load or unload a given set of trucks or other containers each with items from a corresponding set of sources or inputs. Once the layout is determined, robots may be assigned and/or may assign themselves roles to participate in the operation and each may be configured and/or may configured itself as/if needed to perform its assigned function, including by loading or having loaded a configuration data or other data (e.g., form a computer vision or other perception module) that informs the robot of the layout and the spaces within which that robot will operate.

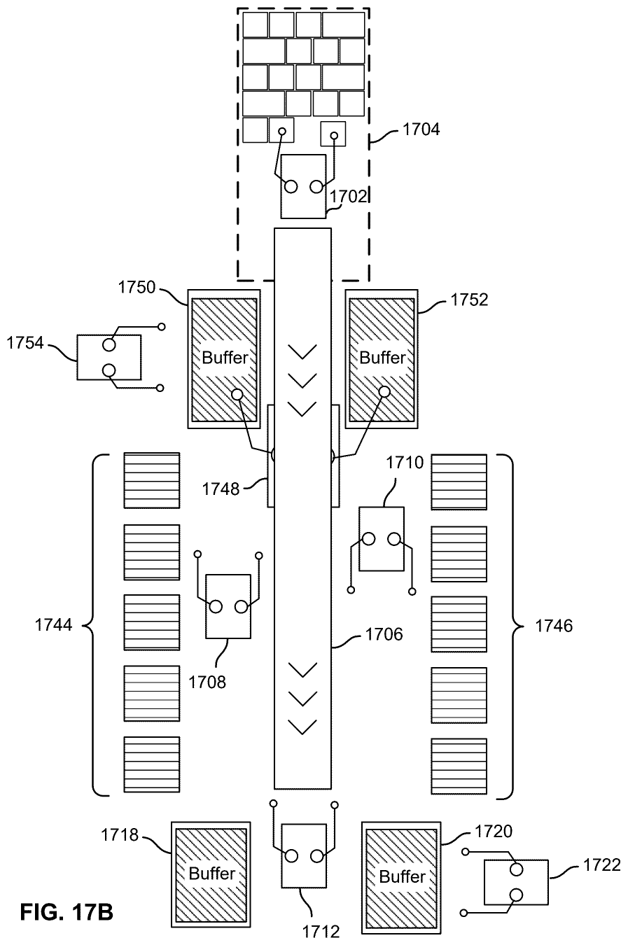

FIGS. 17A and 17B illustrate a multi-purpose robotic system comprising a plurality of robots cooperating to load/unload a truck or other container, including by using buffer zones to hold items for later placement.

In the example shown in FIG. 17A, robot 1702 in truck or container 1704 is configured to load or unload items to/from truck or container 1704. For example, robot 1702 may unload items from truck or container 1704 by picking items from a stack, wall, or pile of items in truck or container 1704 and placing each on conveyor 1706.

Robots 1708 and 1710 operate to pick select items from conveyor 1706 and place each item in a corresponding one of the locations 1714, 1716 accessible to that robot. For example, robot 1708 may pick items destined for pallets or other receptacles at one of the locations 1714, while robot 1710 may pick items destined for pallets or other receptacles at one of the locations 1716.

In some scenarios, the number of unique outputs N may exceed the number of available placement locations M. For example, FIG. 17A shows seven pallet/receptacle locations in each of 1714 and 1716 for a total of fourteen (14) available placement locations. However, the items in truck or container 1704 may be destined for more than fourteen (14) destinations. For example, to fully unload truck or container 1704 to destination pallets or other receptacles it may be necessary to build more than fourteen (14) pallets or other receptacles, even though only a maximum of fourteen (14) can be in the process of being built at a given time.

The solution shown in FIG. 17A is to provide a third robot 1712 working outside of the truck or container 1704, which in this example is positioned to pick items from the end of conveyor 1704, i.e., items that were not picked by robot 1708 or robot 1710, e.g., because the items were not destined for any pallet or receptacle then positioned at any of the fourteen (14) available locations 1714, 1716. Robot 1712 places such items in one or the other of two available buffer areas 1718, 1720. In some embodiments, robot 1712 may place an item in buffer area 1718 based on an indication that the item will later be placed, e.g., by robot 1708 or a helper robot, in a pallet or receptacle that according to plan will in a future time be place in one of the locations 1714 accessible to robot 1708 and similarly may place an item in buffer area 1720 based on an indication that the item will later be placed, e.g., by robot 1710 or a helper robot, in a pallet or receptacle that according to plan will in a future time be place in one of the locations 1716 accessible to robot 1710.

In the example shown, a helper robot 1722 is provided to pick items from the buffer areas 1718, 1720, for example to place them in pallets or other receptacles not shown in FIG. 17A, such as pallets or receptacles in another location. In some embodiments, a helper robot such as robot 1722 may carry items to one of the locations 1714, 1716 on site, e.g., at a later time when a pallet or receptacle with which an item in the buffer area 1718, 1720 is associated is placed at one of the locations 1714, 1716 on site.

To load the truck or container 1704, the buffers may be used to store or stage items to be loaded onto truck or container 1704 but which are not on or in pallets or other receptacles at locations 1714, 1716. For example, if a single item of a given type is required and is not on a pallet, that item may be delivered separately to a buffer area 1718, 1720, e.g., by a helper robot such as robot 1722, and placed by robot 1712 onto the conveyor 1706 for loading.

Referring next to FIG. 17B, the locations 1744, 1746 adjacent to robots 1708, 1710 have been reduced to five locations each to make room for additional buffer areas 1750, 1752 on either side of conveyor 1706 in locations just outside of truck or container 1704. In this example, robot 1748 positioned beneath conveyor 1748 is configured to pick items to be buffered from the top of conveyor 1706 and place them in one of the nearby buffer locations 1750, 1752. Items required to be buffered that are not handled by robot 1748, e.g., because robot 1748 was busy buffering other items at the time the items were conveyed past robot 1748, are placed by robot 1712 in buffer area 1718 or 1720.

In some embodiments, not shown in either FIG. 17A or 17B, the unloader robot 1702 may be configured to place items in buffer areas in the truck or container 1704, e.g., on either side of the conveyor 1706 and/or robot 1702.

In various embodiments, use of one or more buffer zones as described in connection with FIGS. 17A and 17B enables the contents of a truck or container to be unloaded directly to pallets or other receptacles each associated with a corresponding retail store or other downstream destination, for example, even if the number of locations available to place pallets or other receptacles is less than the number of downstream destinations. For example, to unload a truck with items destined for 30 different downstream destinations in a context in which only 10 pallets or other receptacles can be loaded at a time, items destined for locations not associated with a pallet or other receptacle that is in one of the 10 pallet/receptacle locations at the time the item is being unloaded can be unloaded to a buffer, as disclosed herein, then loaded from the buffer to the pallet or other receptacle associated with its downstream destination when that pallet or other receptacle is in one of the 10 spots.

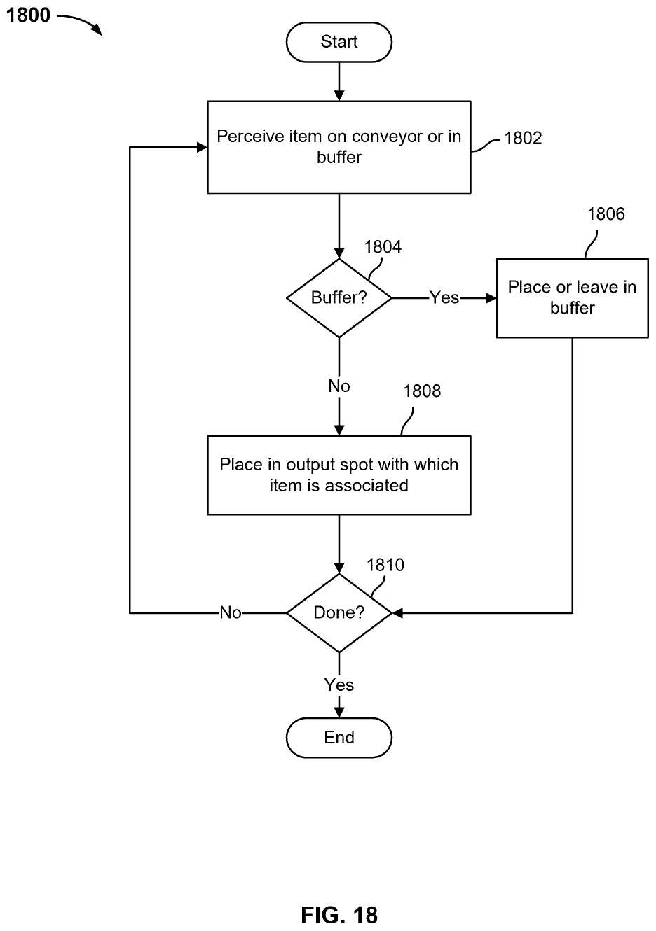

FIG. 18 is a flow diagram illustrating an embodiment of a process implemented by a multi-purpose robotic system comprising a plurality of multi-purpose mobile robots cooperating to load/unload a truck or other container, including by using buffer zones to hold items for later placement. In various embodiments, process 1800 of FIG. 18 may be performed by one or more elements comprising a multi-purpose robotic system as disclosed herein, such as robots 1702, 1708, 1710, and/or 1712 of FIGS. 17A and 17B. In the example shown, at 1802 an item on a conveyor and/or in a buffer area is perceived, e.g., via computer vision. If it is determined at 1804 that the item should be placed or remain in a buffer area, then at 1806 the item is picked from the conveyor and placed in a buffer area, if on the conveyor, or left in the buffer area if already in a buffer area. For example, an item may have been placed in a buffer area previously and the pallet or other receptacle to which it is destined may not yet be available.

If it is determined at 1804 that an item on the conveyor or in a buffer area does not need (or no longer needs) to be buffered, then at 1808 to item is picked (i.e., from the conveyor or the buffer area, as applicable) and placed in an output location with which the item is associated, e.g., a pallet or other receptacle with which the item is associated.

Processing continues until no other items remain either on the conveyor or in the buffer area (1810), at which time the process 1800 ends.

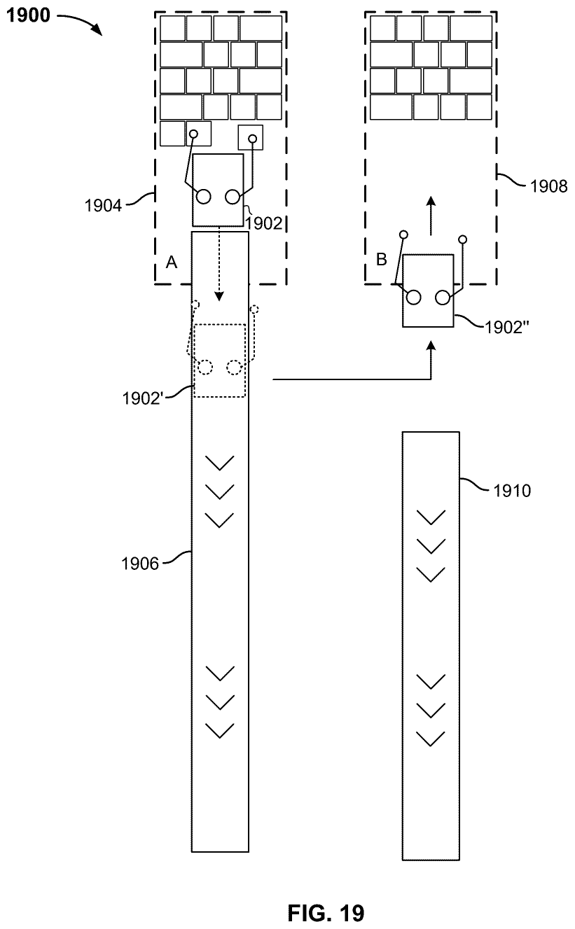

FIG. 19 illustrates a multi-purpose robotic system configured to load/unload items to/from a plurality of trucks or other containers, including by navigating autonomously into, out of, and/or between trucks or other containers. In the example shown, system and environment 1900 includes robot 1902 assigned initially to work to load or unload truck or container 1904 using conveyor 1906. Upon receiving an indication to move on to work instead in truck or container 1908, robot 1902 in this example exits truck or container 1904 while conveyor 1906 remains in position, extending into truck or container 1904, by driving out of truck or container 1904 to an intermediate location 1902′ (robot shown in dotted lines) beneath conveyor 1906, the moving laterally to line up with an entrance door and/or ramp to truck or container 1908 before driving forward to enter truck or container 1908, e.g., to and through position 1902″ as shown.

As shown in FIG. 19, conveyor 1910 associated with truck or container 1908 is not yet extended at the time robot 1902 exits truck or container 1904 and navigates to and enters truck or container 1908, but in other scenarios conveyor 1910 may already have been extended into truck or container 1908, in which case robot 1902 may be configured to navigate to a position beneath conveyor 1910 and drive under conveyor 1910 into position in truck or container 1908.

In some embodiments, robot 1902 may be configured and/or have learned to tuck its robot arms in and down, to reduce its overall height and thereby facilitate operating beneath the conveyors 1906, 1910. In some embodiments, robot 1902 may control and/or signal the extension or retraction of conveyors 1906, 1910, as applicable, to facilitate gaining entrance or exiting truck or container 1904 and/or 1908.

In some embodiments, an expandable conveyor or other material handling equipment may be connected or otherwise mechanically coupled to the back end of robot 1902. Robot 1902 may push the expandable conveyor out of truck or container 1904 as robot 1902 exits, for example, and may pull the expandable conveyor into truck or container 1908 behind robot 1902 as robot 1902 enters truck or container 1908.

In various embodiments, techniques disclosed herein may be used to provide a mobile logistics robot capable of performing palletization/depalletization and/or similar operations efficiently in a variety of contexts.

Although the foregoing embodiments have been described in some detail for purposes of clarity of understanding, the invention is not limited to the details provided. There are many alternative ways of implementing the invention. The disclosed embodiments are illustrative and not restrictive.

1. A mobile logistics robot, comprising:
a mobile chassis having a plurality of independently controllable drive elements;
one or more robotic arms mounted on the mobile chassis;
a processor configured to control the one or more robotic arms and the plurality of independently controllable drive elements as needed to pick items from a set of one or more source locations and place each item in a corresponding destination location included in a set of one or more destination locations, including by using the independently controllable drive elements to move the mobile chassis within a space bounded at least in part by the one or more source locations and the one or more destination locations.

2. The mobile logistics robot of claim 1, wherein the one or more source locations include one or more conveyors, chutes, shelves containers, pallets, or other receptacles.

3. The mobile logistics robot of claim 1, wherein the one or more destination locations includes one or more conveyors, chutes, shelves containers, pallets, or other receptacles.

4. The mobile logistics robot of claim 1, wherein the set of destination locations includes a plurality pallets or other receptacles.

5. The mobile logistics robot of claim 4, wherein the pallets or other receptacles are arranged in a manner that constrains movement of the mobile chassis on two or more sides.

6. The mobile logistics robot of claim 4, wherein the pallets or other receptacles are arranged in parallel rows that define a lane via which the mobile logistics robot is configured to transit to access pallets or other receptacles on either side of a lane.

7. The mobile logistics robot of claim 1, wherein the processor is configured to control the plurality of independently controllable drive elements to move the mobile chassis laterally.

8. The mobile logistics robot of claim 1, wherein the processor is configured to control the plurality of independently controllable drive elements to rotate the mobile chassis about an arbitrary vertical axis.

9. The mobile logistics robot of claim 1, wherein the processor is configured to control one of the one or more robotic arms and the plurality of independently controllable drive elements to move an item continuously and smoothly through a planned trajectory.

10. The mobile logistics robot of claim 9, wherein the planned trajectory starts at a pick location and ends at a place location that was not within reach of the robotic arm when the item was picked at the pick location.

11. The mobile logistics robot of claim 1, wherein the processor is further configured to control the one or more robotic arms and the plurality of independently controllable drive elements to pick an item using one of the one or more robotic arms, move with the item in the grasp of the robotic arm used to pick it to a location associated with a label printer, and manipulate the item, using the robotic arm, to cause a label printed by the label printer to be affixed to the item.

12. The mobile logistics robot of claim 1, further comprising a camera or other sensor and wherein the processor is configured to use image or other sensor data generated by the camera or other sensor to control the one or more robotic arms and the plurality of independently controllable drive elements as needed to pick items from a set of one or more source locations and place each item in a corresponding destination location included in a set of one or more destination locations.

13. The mobile logistics robot of claim 1, further comprising a camera or other sensor and wherein the processor is configured to use image or other sensor data generated by the camera or other sensor to detect one or both of the presence and the approach of a human and to control the one or more robotic arms and the plurality of independently controllable drive elements as needed to ensure the mobile logistics does not endanger the human.

14. The mobile logistics robot of claim 13, wherein the processor uses the image or other sensor data generated by the camera or other sensor to steer the mobile chassis as needed to ensure the human remains at a safe distance.

15. The mobile logistics robot of claim 13, wherein the processor uses the image or other sensor data generated by the camera or other sensor to divert the mobile chassis to a stow location not in the path of the human.

16. The mobile logistics robot of claim 1, wherein the processor is configured to drive the mobile chassis to a position beneath a conveyor or other conveyance structure and to use the one or more robotic arms to pick items from or place items to a surface of the conveyance structure.

17. The mobile logistics robot of claim 16, wherein the processor is further configured to drive the mobile chassis fore and aft along a longitudinal access of the conveyor or other conveyance structure as needed to use the one or more robotic arms to pick items from or place items to a surface of the conveyance structure.

18. A method to control a mobile logistic robot comprising a mobile chassis having a plurality of independently controllable drive elements and one or more robotic arms mounted on the mobile chassis, the method comprising using a processor to control the one or more robotic arms and the plurality of independently controllable drive elements as needed to pick items from a set of one or more source locations and place each item in a corresponding destination location included in a set of one or more destination locations, including by using the independently controllable drive elements to move the mobile chassis within a space bounded at least in part by the one or more source locations and the one or more destination locations.

19. The method of claim 18, wherein one or both of the source locations and the destination locations comprise pallets or other receptacles arranged in a manner that constrains movement of the mobile chassis on two or more sides.

20. A computer program product embodied in a non-transitory computer readable medium and comprising computer instructions to control a mobile logistic robot comprising a mobile chassis having a plurality of independently controllable drive elements and one or more robotic arms mounted on the mobile chassis, the computer instructions including computer instructions to control the one or more robotic arms and the plurality of independently controllable drive elements as needed to pick items from a set of one or more source locations and place each item in a corresponding destination location included in a set of one or more destination locations, including by using the independently controllable drive elements to move the mobile chassis within a space bounded at least in part by the one or more source locations and the one or more destination locations.
